(19) United States
(12) Patent Application Publication
(10) Pub. No.: US 2024/0302533 A1
(43) Pub. Date: Sep. 12, 2024

(54) Method for Generating Substitute Correction Data for GNSS-Based Localization

(71) Applicants: Robert Bosch GmbH, Stuttgart-Feuerbach (DE); U-Blox AG, Thalwil (CH)

(72) Inventors: Zhibo Wen, Abstatt (DE); Thomas Speth, Denkendorf (DE); Peter Zobel, Stuttgart (DE); Matthew Goode, Thalwil (CH); Chris Hide, Thalwil (CH); Alex Parkins, Thalwil (CH)

(21) Appl. No.: 18/551,457

(22) PCT Filed: Mar. 23, 2022
(86) PCT No.: PCT/EP2022/057597

§ 371 Date: Sep. 20, 2023

(30) Foreign Application Priority Data
Mar. 23, 2021 (DE) 10 2021 107 213.1

(51) Int. Cl. G01S 19/07

(52) U.S. Cl. CPC G01S 19/07

(57) ABSTRACT

A method for generating substitute correction data for GNSS-based localization of a mobile device is disclosed. The method includes: a) recognizing that receipt of correction data from at least one correction data source is currently impaired, b) reading of correction data that has been received earlier, and c) generating substitute correction data for the current situation by using at least part of the correction data that has been received earlier.

The invention relates to a method for generating substitute correction data for GNSS-based localization of a mobile device. Additionally, a computer program, a machine-readable storage medium and an installation for GNSS-based localization of a mobile device are described. The method can be applied in connection with automated or autonomous driving, for example.

### START OF THE ART

Positioning by means of GNSS (e.g. GPS) is determined by measuring the propagation time of GNSS signals and trilateration. However, the propagation time measurement is usually subject to errors. It is usually the case that broadcast satellite orbit and clock data deviate from the actual values. Furthermore, hardware delays in the signal generation on the satellite are a common reason for delays. In addition, refraction and propagation in different atmospheric media lead to propagation delays of the satellite signals compared to the speed of light in a vacuum.

These errors in the propagation time measurement can be reduced by means of correction data. Known methods for this are for example differential GNSS (dGNSS), Real-Time-Kinematic (RTK) or Precise Point Positioning (PPP).

Basically, the methods of use of correction data and the necessary correction data can be categorised in two classes: Observation Space Representation (OSR) and State Space Representation (SSR). For the use of OSR corrections, the user (rover) must be in the vicinity of the reference station (base), otherwise the assumption of elimination/reduction of errors due to the difference between base and rover observations is no longer given. However, this limitation of the method can be overcome with network techniques (e.g. Virtual Reference Station (VRS)) at the expense of bilateral communication, i.e. the rover must first send data (e.g. position) to the reference before it can receive and use correction data.

This is opposite to the SSR principle, which is based on unilateral communication (broadcast) of corrections. Especially for corrections that are not globally valid (e.g. propagation in different atmospheric layers) model parameters are sent. The rover then adapts to its (rough) position and transforms it so that the correction data can be applied to the observations of the rover. In addition, all corrections that become obsolete due to transmission latency and transmission rate must be adapted to the current time. This is especially important if the correction data stream is interrupted and the corrections must therefore be extrapolated for a longer period of time.

When sending the correction data stream, interruptions/communication disturbances may occur regardless of the communication technology used (e.g. radio/satellite broadcast, Internet, vehicle-to-vehicle communication, etc.). This means that no current corrections are available to the rover.

On this basis, a particularly advantageous method for the generation of substitute correction data will be presented, here

### DISCLOSURE OF INVENTION

The invention describes a method for generating substitute correction data for GNSS-based localization of a mobile device, comprising at least the following steps:
a) Recognizing that receipt of correction data from at least one correction data source is currently impaired,
b) Reading of correction data that has been received earlier,
c) Generating substitute correction data for the current situation by using at least part of the correction data that has been received earlier.

Steps a), b) and c) can be carried out, for example, at least once and/or repeatedly in the specified sequence in order to carry out the method. Furthermore, steps a), b) and c), in particular steps a) and b), can be carried out at least partially in parallel or simultaneously.

The method can form an advantageous procedure to bridge breaks in the received correction data stream by extrapolating previously received correction data (especially the correction value and the associated standard deviation or variance). This allows the advantage of a precise position to be determined even in such situations (of breaks or data failure in the received correction data stream). According to a preferred embodiment, the method can be carried out for advantageously bridging a GNSS correction data failure by means of adaptive extrapolation.

GNSS is the abbreviation for Global Navigation Satellite System and can comprise one or more of GPS, Galileo, GLONASS and Beidou systems, for example. GNSS-based localization procedures usually comprise runtime measurements of GNSS satellite signals. In addition, a GNSS-based localization procedure can use further information relevant for determining the current position of the mobile device, such as sensor information, in particular from one or more environmental sensors (e.g. camera, RADAR, LIDAR, ultra-sonic, etc.), and/or map data from a digital map, for example.

The term “substitute correction data” is intended to describe data which is artificially generated by the proposed method, in order to replace/substitute and/or supplement correction data from at least one correction data source. Typical correction data sources are correction data providers or servers of correction data providers, respectively. Usually, these correction data providers supply mapped correction data describing, in particular runtime errors of GNSS signals to be expected at certain points on earth. The said runtime errors can be caused by atmospheric delays of signal propagation, in particular in the earth's ionosphere, for example. However, the provided correction data can also describe additional or alternative influences to GNSS signals like Orbit, Clock, Code Bias, Phase Bias, lonosphere and/or Troposphere.

The mobile device can be any sort of portable or mobile device. According to an advantageous embodiment, the mobile device is a vehicle such as an automobile or car, for example. The mobile device can be configured for automated or autonomous driving operation.

In step a), a recognizing that receipt of correction data from at least one correction data source is currently impaired is carried out. This recognizing can be carried out by an installation for GNSS-based localization of the mobile device. It can be recognized that receipt of correction data from at least one correction data source is currently impaired, when expected correction data from at least one correction data source is not received or received in a disturbed form. Of course, it can also be recognized in step a) whether correction data from two or more correction data sources is currently impaired.

Interruption of the receipt of correction data in step a) can take place, for example, in case a receipt of a correction data stream is interrupted due to the loss of a mobile data transfer connection through which the correction data stream is provided. Another reason for the interruption in the reception of correction data may be the failure of a hardware component that processes the correction data. Interruption of the receipt of correction data is a very strong case of impairment of correction data in step a). Step a) and the further method can also be carried out in a less strongcases of impairment of correction data. This can be a reduction of data transfer rates of one or more data streams (for example mobile connections) that are used to transfer correction data. In particular if such reductions are recognized the method can be started.

Another (additional or alternative) example for recognizing impairment might be that there are (internal or external) flags that indicate that an impairment might occur. Such flags can be set in a computer program code implemented in the mobile device and can, for example, be read (and thus recognized) by an installation for GNSS-based localization of the mobile device. Such flags can be set for example based on navigation and/or sensor data, for example in case a vehicle moves into a tunnel. Such flags can be set in advance, for example based on map data, and/or updated during operation of the mobile device, for example based on navigation and/or sensor data. Various further cases of impairment are included here.

In step b), a reading of correction data that has been received earlier is carried out. Such earlier received correction data refers, in particular, to correction data that has been received earlier by the mobile device and/or the installation for GNSS-based localization of the mobile device from (the) at least one correction data source. Such earlier received correction data can, for example, be stored in a storage means (e.g. a digital memory) of the mobile device. The storage means can be part of the installation for GNSS-based localization of the mobile device or can be connected/connectable therewith (so that the installation can read data from the storage means).

In step b), correction data which was received earlier is preferably read from a memory store. Preferably, this correction data was received from the source of correction data which is not available and interrupted according to step a). Usually, a list of data points (or data samples) of one type of correction data are received with a certain frequency permanently-for example every 5 seconds. Every data point of correction data can be stored in a memory for a certain time. For example, an amount of 50, 100 or 200 (past) data points can be available in a memory at any time.

In particular, correction data received in a time interval before the failure of the correction data stream is read in step b). Preferably a plurality of data points within this time interval are read out. It is particularly preferred to read out as many data points as are required for an extrapolation of the correction data into the future or current time, respectively.

In step c), the generating of substitute correction data for the current situation by using at least part of the correction data that has been received earlier is carried out. This step of generating can include a procedure of extrapolating from at least one part, advantageously two or more parts (data sets with different time stamps), of the correction data that has been received earlier up to the current time/situation. Additionally or alternatively, the step of generating can include a procedure of interpolating between two or more parts (data sets with different locations) of the correction data that has been received earlier with regard to the area or around the area in which the mobile device is currently situated.

Generated substitute correction data in particular includes the correction value itself as well as an associated standard deviation or variance that describes an uncertainty of these values. The substitute correction data can, for example, include a correction value as well as an information about the integrity of this correction value.

The generation of substitute correction data in step c) can be done by use of different mathematical approaches/procedures which are described in more detail below.

According to a preferred embodiment, the generation of the substitute correction data is carried out adaptively.

An adaptive approach to generate substitute correction data involves that parameters, mathematical approaches/procedures etc. can be adapted to the current situation within the substitution. For example, it is possible to change the approach to calculate corrections as soon as certain time intervals with impaired receipt of correction data has taken place. For example, it is possible to use a first approach (parameters, mathematical approach etc.) for the first 60 seconds after a loss of receipt of correction data and to use a second approach for the next 60 seconds (seconds 60 to 120) after a loss of receipt of correction data.

A further approach of adaptive generation of the substitute correction data is to change the approaches/parameters/functions to generate the substitute correction data over lifetime of the mobile device. An adaption of the generation of the substitute correction data can take place when the correction data service that provides the correction data changes the provision of the correction data. A change of the correction data service can cause the need of other extrapolation approaches. A change of the correction data service can include an improvement in the quality of the correction data or a change in the format/frequency etc. of the provided correction data.

The correction data provided by the correction data service can also have quality fluctuations. Such quality fluctuations can have the effect that other/amended extrapolation functions (for example polynomials of another order and/or with other parameters) might be more advantageous. Such quality fluctuations can therefore be a reason to change the generation of substitute correction data, adaptively.

In a preferred embodiment of the method, an optimal function for generation of substitute correction data by extrapolation is determined in a central unit and then distributed to the mobile devices in which steps a), b) c) take place. Such a determination can be done by comparing generated substitute correction data with original correction data as long as original correction data is available. The determination of an optimal function for generation of substitute correction data can involve the determination of polynomials, polynomial parameters etc. All such data is data that describes the way of determining the substitute correction data in step c). All such data can be sent to the mobile device frequently to adapt the way/function of generating substitute correction data. The determination of an optimal function for generation of substitute correction data can also involve a frequent test of the way/function of generating substitute correction data which is active in at least one mobile device. Within such a test, it can be checked whether the way/function of generation is still sufficient to generate substitute correction data of a sufficient quality in certain situations. It is a further possibility to release updates (functions, polynomials, parameters) to adapt the way/function of determining substitute correction only in situations in which the quality is no longer sufficient. Updates of the way/function of determining substitute correction can in particular involve an estimation of the length of the time interval in which extrapolated substitute correction data can be used.

According to a further preferred embodiment, the generation of the substitute correction data is carried out by using at least one extrapolation procedure.

The general approach of extrapolation is to use at least two data points in the past to define a curve which enables the calculation of any data point in the future, such as at the current time, for example. Here, all available approaches to extrapolate data can be used.

According to a further preferred embodiment the extrapolation procedure is an adaptive extrapolation procedure.

An adaptive extrapolation procedure involves at least one parameter of an extrapolation function or at least one mathematical approach of an extrapolation function that can be adapted due to the available situation. The extrapolation function can in particular be changed with regard to the time that has lapsed after loss of receipt of correction data.

According to a further preferred embodiment, the generation of the substitute correction data is carried out by using Lagrange polynomials.

Lagrange polynomials are an efficient approach to calculate an extrapolation. By choosing the order of a Lagrange polynomial to calculate the extrapolation. certain effects of the extrapolation can be advantageously defined.

In usual applications, a correction service, as a correction data source, provides orbit, clock, code bias, phase bias, ionosphere and troposphere correction data. The correction data points can be extrapolated using Lagrange polynomial functions. Such Lagrange polynomial functions can be built up efficiently for each individual extrapolation which is done in step c). The order of the polynomial functions can be variable. An order of “0” applies to a constant extrapolation. An order “1” applies to a linear extrapolation. An order of “5” applies to a polynomial extrapolation with a polynomial of fifth order. The order of the polynomial function can be adaptively chosen. The functions (and in particular the order) can be determined by considering the history of previously received correction data points, in particular data points which were received in a time interval before loss of receipt of the correction data. In some situations a polynomial functional with order “1” (linear extrapolation) might be a good approach. In other situations, a higher order is more recommendable.

It is furthermore preferred that the generating of the substitute correction data comprises a selection of at least one estimation procedure from a plurality of different estimation procedures.

Preferably the estimated procedures are stored as available procedures and/or functions to be filled with data points from the past in a memory. Depending on the present situation the selection of one estimation procedure which is used for the estimation can take place.

According to a further preferred embodiment the method also comprises the following step:
d Determining at least one estimation error for the substitute correction data generated in step c).

Step d) can be executed at any time during the execution of the method (before, after and/or in parallel to step a), before, after and/or in parallel to step b), before, after and/or in parallel to step c)).

The estimation error determined in step d) itself is preferably estimated by an approach which enables objective judgement of the quality of estimation by means of extrapolation. According to a preferred embodiment, a-priori knowledge or expert knowledge which is deposited in a data store is used to determine an estimation error. Preferably the approach to determine the estimation error of the correction date is not influenced by the uncertainty of the estimation itself. A preferred approach to collect data that can be used for determining an estimation error comprises comparing extrapolated substitute correction data with received (original) correction data in situations where both are available. Such situations can be used to collect data regarding plausible estimations for times where it is not possible to receive correction data and to determine estimation errors in such situations.

Preferably, the function with the parameters that show the smallest extrapolation errors is selected by means of the estimated error. Preferably, this is done adaptively.

It is furthermore preferred that an uncertainty is added to a determined estimation error. The additional uncertainty is chosen to reflect the extrapolation error.

Within an adaptive approach it is for example possible that a maximum time interval for use of substitute correction data generated by polynomial functions is set. For example, such a time interval can be defined in seconds or minutes. It can be different for different types of correction data.

For example for orbit correction data, a time interval of about 5 min can be appropriate. The time interval for troposphere correction data is preferably at least two times longer, for example about 15 min. Several different time intervals can be defined for correction data regarding orbits, clocks etc. The definition of the time interval is preferably given under consideration of physical aspects of each individual error that is compensated by means of the correction data.

Within the time interval for polynomial functions for generating substitute correction data it is preferred to define different sub time intervals in which different polynomial functions are used for generating the substitute correction data. For example, it is preferred that there is at least a first time interval directly after the end of receipt of (original) correction data and a second time interval that directly follows the first time interval. Usually the order of a polynomial function that is used for extrapolation is reduced with increasing time after end of receipt of (original) correction data. In a first time interval it is a preferred option to use a quadratic function (“2” order) and/or a function of order “5”. In a second time interval it is a preferred option to use a function of “1” order (linear function). For the duration of the time intervals it is preferred that the first time interval has a duration of ⅓ of the complete use time of polynomial functions for generating substitute correction data while the second time interval has a duration of ⅔ of the complete use time of polynomial functions for generating substitute correction data.

The extrapolation of correction data might also be done with different approaches for different parts of the correction data. Above, it is explained that correction data usually consists of different types of data, in particular the correction values itself as well as a variance of standard deviation of the correction values which describe an uncertainty of these values. It is common to use different functions/parameters/approaches to calculate the correction values itself as well as the parameters for variance/standard deviation. In particular, in the case that Lagrange polynomials functions are used for extrapolation it is advantageous that the order of polynomials for calculating the variance/standard deviation parameters is higher than the order of polynomials for calculating the correction values. In particular, for the variance/standard deviation parameters it is common that they become more uncertain over time.

The method can be applied on the one hand during development. In such a use a set of data points of correction data can be determined/generated once and can then be recognized as (virtually) receipt correction data (step a). Afterwards and according to step b) and c) further test data can then be generated.

However and according to a preferred embodiment, the method is directly integrated into an algorithm and used in the field, so that the method can be used to provide a constant stream of correction data with high quality even in cases where a receipt of correction data is impaired. In this way, it is possible to react to quality fluctuations of the correction data during the product life cycle, for example. Examples of changes in the quality of correction data can occur in case a correction data service that provides the correction data changes its quality of service. In most cases this will be a quality improvement but the situation that the quality of correction data decreases can also occur. In most cases correction data and the ability to do corrections based on this correction data will be improved in the future because errors become more stable. For instance more accurate clocks of future satellite generations will have a significant effect in this regard.

In a further preferred embodiment of the invention the method step c) is divided into two steps. In a first step c1) the best possible extrapolation is sought for each correction value. In the following example this is explained in connection with the figures, Lagrange's polynomials are used for this purpose. Other inter/extrapolation methods would also be conceivable. In the second step c2), best possible extrapolation is estimated. In particular, the standard deviation associated with the correction value is extrapolated. In some embodiments of the method and regarding some type of correction data a polynomial extrapolation of the correction values themselves is not suitable. It might be rather useful to keep them constant in case of impairment of receipt of (original) correction data.

It is furthermore an object to propose a computer program, configured for carrying out the above-described method. In other words, this relates particularly to a computer program (product) comprising instructions which, when the program is executed by a computer, cause the computer to perform a method described herein.

The computer program can be installed on a hardware in a mobile device or vehicle to generate substitute correction data.

It is furthermore an object to propose a machine-readable storage medium, on which the computer program is stored. For example, the machine-readable storage medium can be a computer-readable data carrier or memory.

Furthermore, an installation for GNSS-based localization of a mobile device, configured for carrying out the above-described method is proposed. The installation for GNSS-based localization may comprise, for example, a computer and/or a control device (controller) that can execute commands to carry out the method. To this end, the computer and/or controller can, for example, execute the specified computer program. For example, the computer and/or controller may access the specified storage medium to execute the computer program. The installation for GNSS-based localization can, for example, be a motion and position sensor or be part of such sensor. The installation for GNSS-based localization can be arranged in or at a vehicle.

In a further alternative embodiment, the computer program can be installed and executed on a central server unit that calculates the substitute correction data for various mobile devices one time. The substitute correction data can then be distributed to each vehicle over an alternative data link, for example a mobile radio.

The details, features and advantageous embodiments described in connection with the method can correspondingly also occur in the computer program and/or the storage medium and/or the installation presented here and vice versa. In this respect, reference is made in full to the explanations there for the more detailed characterization of the features.

In the following, the invention shall be described by means of the figures in more detail. The figures show the technical context and preferred embodiments and explanative examples. The disclosure is not limited to the figures and can be combined with all other disclosure above.

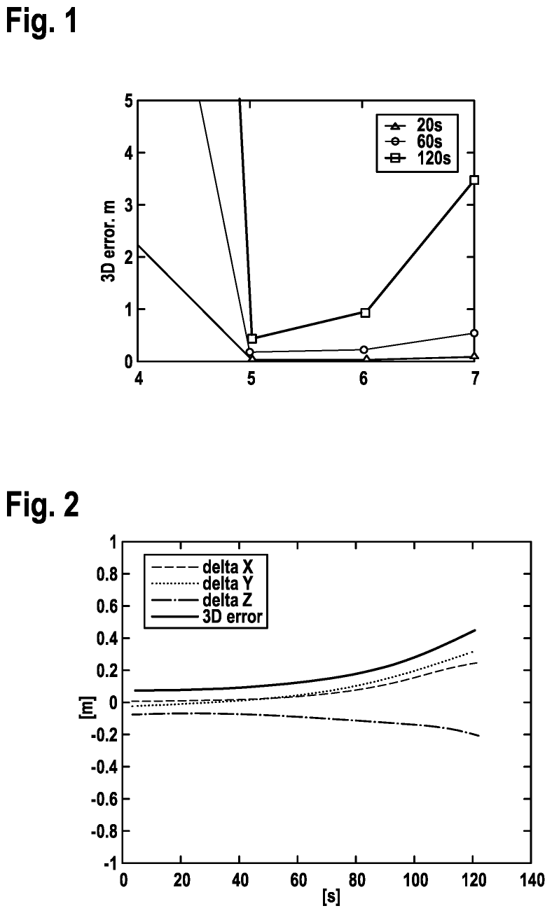

FIG. 1: Extrapolation error as a function of Lagrange's order (4-7),

FIG. 2: Effect of extrapolation error on positioning accuracy with use of Lagrange's order (5),

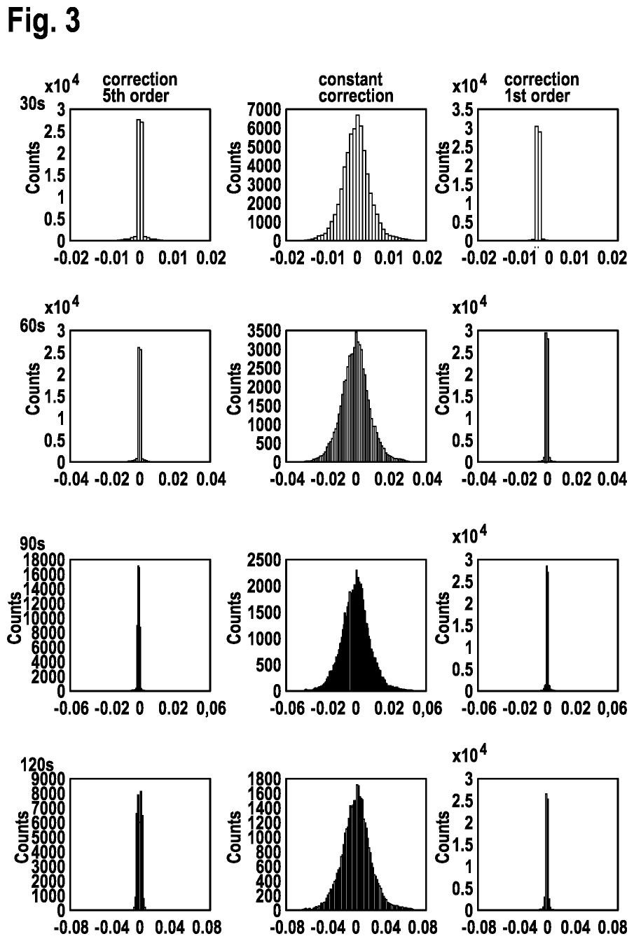

FIG. 3: Comparison of extrapolation according to Lagrange's order 0, 1 and 5,

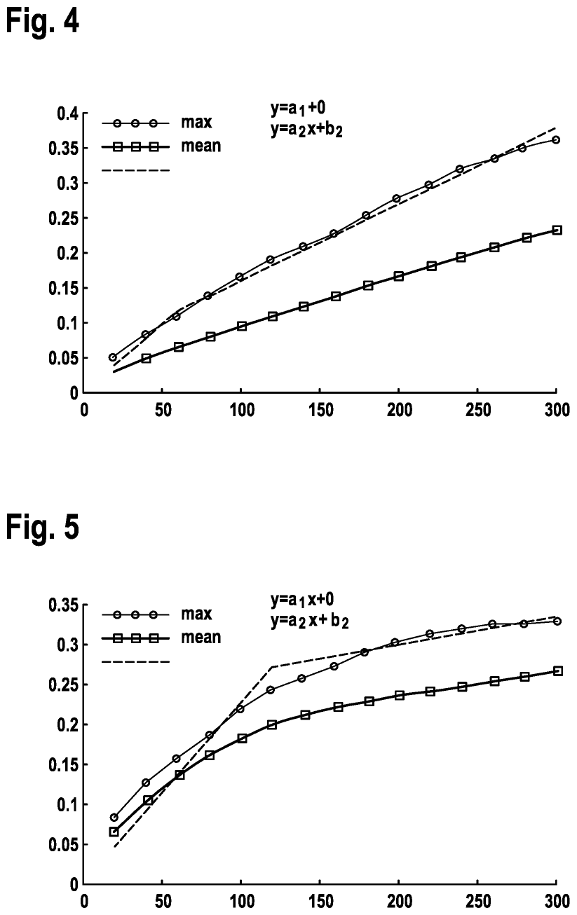

FIG. 4: Error of ionospheric corrections with constant extrapolation,

FIG. 5: Error of tropospheric corrections with constant extrapolation,

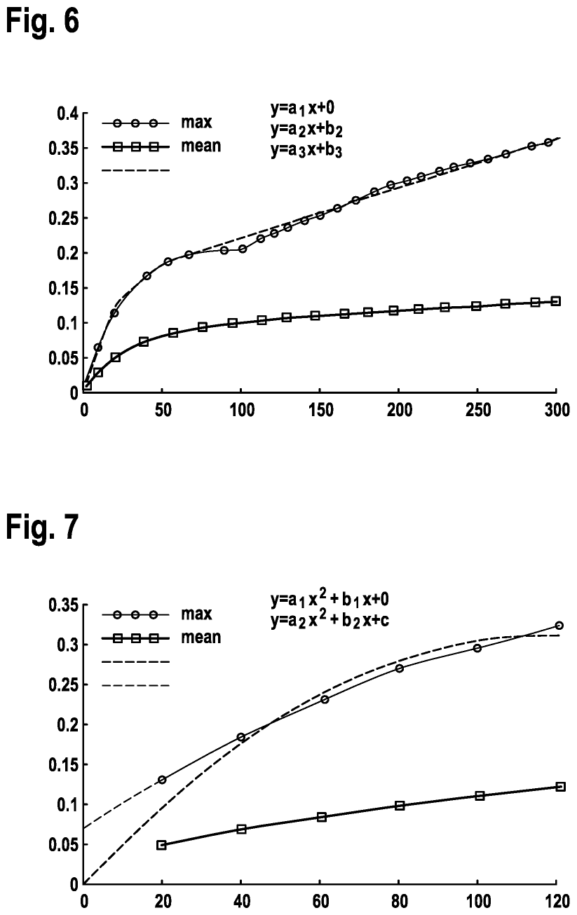

FIG. 6: Error of clock corrections with constant extrapolation for GPS satellites,

FIG. 7: Error of clock corrections with constant extrapolation for GLONASS satellites,

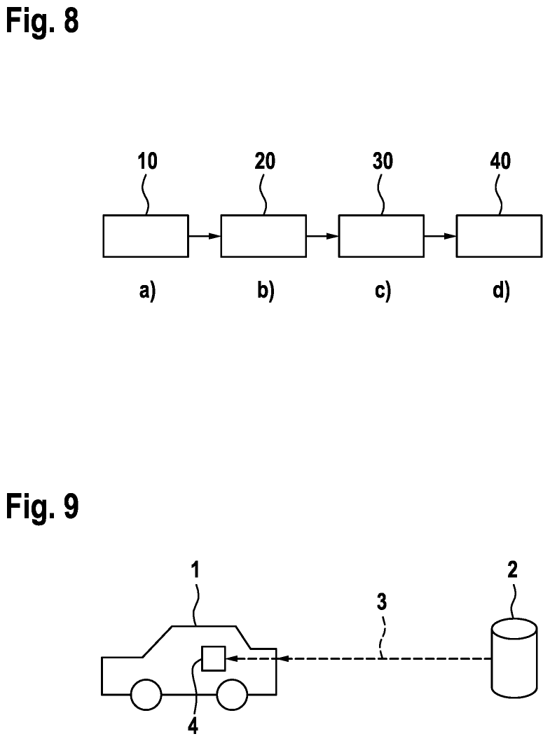

FIG. 8: A flow diagram of the method, and,

FIG. 9: A schematic illustration of a situation in which correction data is received in a mobile device.

The figures all apply to an advantage regarding orbit correction data. The teaching of the example can also be applied to other types of correction data (satellite clock, ionosphere, etc.). In connection to the figure description further advantageous features are described which are not linked to the example of orbit correction data and which can be used to further specify the method.

FIG. 1 shows the effect the order of a polynomial extrapolation function can have on the accuracy of extrapolation. FIG. 1 shows the 3D error in meters on the Y-axis as a function of the polynomial order on the X-axis. FIG. 1 shows three curves for different times after the start of extrapolation of data. FIG. 1 shows that for all curves there is a minimum with Lagrange's 5th-order.

However, FIG. 1 also shows that with Lagrange's 5th-order polynomial the error rate increases for longer extrapolation times. Therefore, for certain extrapolation times (e.g. 30, 60, 90, 120 s) the best polynomial is used. The increase of error with Lagrange's 5th-order polynomial is further investigated in FIG. 2. FIG. 2 shows four curves which illustrate the 3D error from FIG. 1 for the case of Lagrange's 5th-order polynomial. Additionally to the (complete) 3D error, FIG. 1 shows curves for separated errors delta X, delta Y and delta Z. The error in meters is plotted on the Y-axis over time on the X-axis.

The following example in FIG. 3 with the orders 0, 1 and 5 shall show what it means to choose the best polynomial order for each time interval. FIG. 3 shows 12 separate diagrams in a matrix. The rows of the matrix applies to times of 30 seconds, 60 seconds, 90 seconds and 120 seconds after starting extrapolation. The first column applies to polynomial extrapolation according to order “5”. The second column applies to a constant correction which is equivalent to a polynomial order “0”. The third column applies to a polynomial extrapolation according to order “1” (linear extrapolation). Each diagram shows a Gaussian distribution of errors. On the X-axis the error in meters is plotted. On the Y-axis a number of counts of data values (samples) is shown. The sharper the Gaussian distribution is, the more precise is the extrapolation function. The resolution on the X-axis of the diagrams in FIG. 3 changes from row to row. In row 1 the resolution is −0.02 to 0.02. In row 2 the resolution is −0.04 to 0.04. In row 3 the resolution is −0.06 to 0.06. In row 4 the resolution is −0.08 to 0.08. This must be taken into account while reading the diagrams. In particular column 1, row 4 shows that Lagrange's 5th-order polynomial develops to be less suitable after longer times since the sharpness of the distribution gets reduced. In contrast to this constant correction and correction according to 1st order does not have such a strong loss of accuracy after longer times.

For an extrapolation time of 30 s, the 5th order and 1st order (linear extrapolation) are approximately equal, so that both can be applied for this time period. For longer extrapolation times, linear extrapolation provides better values. Now, for example, a 5th-order polynomial could be used up to 45 s and a 1st-order polynomial from this time on. In general, however, it is also a preferred embodiment to use only one polynomial for the complete extrapolation.

The maximum extrapolation in which polynomials of a specific order are useful is different for the different types of correction. Essentially, they depend on the rate of change of the errors to be corrected and thus on the physical properties on which they are based. For example, code and phase bias is a very slow changing value and therefore allows long extrapolation times (e.g. 15-30 min) without significantly increasing the extrapolation error. In tropospheric corrections, it is mainly the humity percentage in the atmosphere and thus weather changes that are important. Depending on the region and season, the weather changes at different rates. For example, 15 min can be assumed for a central European summer thunderstorm. In the South-East Asian monsoon, on the other hand, the weather can change within a few minutes (e.g. 2 min). Therefore, a regional adaption of the Lagrange polynomial (in particular its order), can be a suitable solution.

Regional and seasonal adaptions can thus be taken into account. The same applies to ionospheric corrections. These change with solar activity. Thus, long extrapolation times (e.g. 15 min) are possible at night. The maximum possible extrapolation time increases during the day as the latitude decreases so that only a few minutes can be extrapolated (e.g. 2-5 minutes). Especially for the ionosphere, a (state of the art) monitor (e.g. geometry-free linear combination) is recommended, since a magnetic storm, caused by strong solar activity, leads to rapidly changing environmental conditions and thus to incorrect extrapolation values.

The change in clock corrections can best be compared with noise, the strength of which correlates with the type of clocks installed in the satellites. Thus, the maximum extrapolation time depends on the type of satellite and may change with future satellite generations. On the other hand, the physical properties of ionosphere and troposphere usually do not change, so that their maximum extrapolation time remains the same.

Above, it is described that for the estimation of standard deviation/variance different functions/approaches than for estimation of correction values themselves can be applied. Approaches to estimate standard deviation/variance are explained by means of the FIGS. 4, 5, 6 and 7. FIG. 4 shows an error of ionospheric corrections with constant extrapolation. FIG. 5 shows an error of tropospheric corrections with constant extrapolation. FIG. 6 shows an error of clock corrections with constant extrapolation for GPS satellites. FIG. 7 shows an error of clock corrections with constant extrapolation for GLONASS satellites.

The aim is to select a suitable standard deviation so that it reflects the error or inaccuracy of the correction value during the time interval of estimation of correction data/time interval of generating substitute correction data. Preferably, this estimated standard deviation/variance data is part of the generated substitute correction data generated according to method step c). A suitable approach is that three times the standard deviation should envelop the extrapolation error of the correction values. The following examples shown in FIGS. 4, 5, 6 and 7 illustrate this.

All these figures show the extrapolation time on the X-axis and an error in meters on the Y-axis. In each FIG. 4, 5, 6, 7 a family of curves for original correction data (not generated) is shown in the background. Furthermore, a mean is shown which corresponds to the correction value. For representing a region of the diagrams which should be covered by a standard deviation/variance around this mean curve, a maximum curve is shown. This maximum curve can be approximated by a calculation by means of a mathematical function. FIG. 4, FIG. 5 and FIG. 6 give examples regarding linear functions for this purpose. According to FIGS. 4 and 5, two straight lines are used for this purpose. According to FIG. 6, three straight lines are used for this purpose. According to FIG. 7, a quadratic “2” order function is used. Here it can be seen that the function without zero crossing better represents the maximum error (in the extrapolation time shown). This means, however, that this function should not be used for very short extrapolation times, because for extrapolation times towards zero, the extrapolated error also goes towards zero. Thus, a function with zero crossing should be used here.

FIG. 8 shows a schematic diagram of the described method with method steps a) 10, b) 20, c) 30 and d) 40.

FIG. 9 shows a schematic illustration of a situation in which correction data from a correction data source 2 is received by a mobile device 1 in form of a data stream 3 which includes correction data values and preferably also standard deviation/variance values. In this example, the mobile device 1 is a vehicle. In the mobile device 1 there is an installation 4 which executes the method.

1. A method for generating substitute correction data for GNSS-based localization of a mobile device, comprising:
a) recognizing that receipt of correction data from at least one correction data source is currently impaired,
b) reading of correction data that has been received earlier, and
c) generating substitute correction data for the current situation by using at least part of the correction data that has been received earlier.

2. The method according to claim 1, wherein the generating of the substitute correction data is carried out adaptively.

3. The method according to claim 1, wherein the generating of the substitute correction data is carried out using at least one extrapolation procedure.

4. The method according to claim 3, wherein the extrapolation procedure is an adaptive extrapolation procedure.

5. The method according to claim 1, wherein the generating of the substitute correction data is carried out using Lagrange polynomials.

6. The method according to claim 1, wherein the generating of the substitute correction data comprises selecting at least one estimation procedure from a plurality of different estimation procedures.

7. The method according to claim 1, further comprising:
d) determining at least one estimation error for the substitute correction data generated in step c).

8. A computer program configured for carrying out a method according to claim 1.

9. A machine readable storage medium on which the computer program according to claim 8 is stored.

10. An installation for GNSS-based localization of a mobile device configured for carrying out a method according to claim 1.
